(19) United States
(12) Patent Application Publication
(10) Pub. No.: US 2026/0216645 A1
(43) Pub. Date: Jul. 30, 2026

(54) ADSORBER, ADSORPTION SYSTEM AND ADSORPTION METHOD

(71) Applicants: China National Petroleum Corporation, Beijing (CN); CNPC Research Institute of Safety and Environmental Technology, Co. Ltd., Beijing (CN)

(72) Inventors: Aiguo ZHOU, Beijing (CN); Jiale ZHENG, Beijing (CN); Fanxin KONG, Beijing (CN); Chuanruo YANG, Beijing (CN); Wei WEI, Beijing (CN); Jinfu CHEN, Beijing (CN)

(21) Appl. No.: 19/574,206

(22) Filed: Mar. 20, 2026

Related U.S. Application Data
(63) Continuation of application No. PCT/CN2024/136128, filed on Dec. 2, 2024.

(30) Foreign Application Priority Data
Mar. 25, 2024 (CN) 202410346473.0

(51) Int. Cl. B01D 53/82; B01D 53/34; B01D 53/62; B01D 53/96

(52) U.S. Cl. CPC B01D 53/82; B01D 53/346; B01D 53/62; B01D 53/96; B01D 2253/20; B01D 2257/504; B01D 2258/06; B01D 2259/4009

(57) ABSTRACT

This application provides an adsorber, including: a housing with a cavity therein; a plurality of spaced adsorption bed layers and airflow distribution plates, located in the cavity; where air inlets of the housing are configured to respectively inject a gas to be adsorbed and a regeneration gas into the cavity, and air outlets of the housing are configured to discharge an adsorbed gas and a desorbed gas; interval between two adjacent adsorption bed layers constitutes a channel, and the channel is respectively communicated with the air inlet and the air outlet, with a width of the channel gradually decreasing along a direction from the air inlet toward the air outlet; inlets of the airflow distribution plates are communicated with the air inlets, and outlets of the airflow distribution plate face the adsorption bed layers; and the airflow distribution plate has gradually decreasing aperture diameters from the inlets to the outlets.

### CROSS-REFERENCE TO RELATED APPLICATIONS

This application is a continuation of International Application No. PCT/CN2024/136128, filed on Dec. 2, 2024, which claims priority to Chinese Patent Application No. 202410346473.0, filed with the China National Intellectual Property Administration on Mar. 25, 2024, and entitled “Adsorber, Adsorption System and Adsorption Method”. The disclosures of the aforementioned applications are hereby incorporated by reference in their entireties.

### TECHNICAL FIELD

The present application relates to the field of direct air capture of carbon dioxide and, in particular to an adsorber, a direct air capture system, and an adsorption method.

### BACKGROUND

With the continuous increase in global greenhouse gas emissions, climate change has become a global issue. Many regions have committed to achieving the goals of net-zero emissions or carbon neutrality within the coming decades. Direct air capture (DAC) technology offers an effective means to realize these objectives by removing carbon dioxide from the atmosphere, thereby contributing to climate change mitigation and greenhouse gas reduction. Despite DAC having significant potential for climate change mitigation, it requires addressing a series of challenges and bottlenecks for its widespread adoption.

The application of DAC technology involves constructing large-scale adsorbers and associated infrastructure. Large adsorbers have been evolving toward larger scale and lower energy consumption. The emergence of vertical radial flow adsorbers has effectively addressed issues such as a large footprint of vertical axial flow adsorbers and horizontal vertical flow adsorbers, as well as difficulties in leveling molecular sieve bed layers. However, nowadays with further increase in air processing volumes and the low concentration of CO₂ in air, high-throughput and low-concentration direct air capture systems commonly suffer from problems such as high system pressure drop and low efficiency of adsorption and desorption.

### SUMMARY

The present application provides an adsorber for solving the problems in the prior art, such as high system pressure drop and low efficiency of adsorption and desorption arising when performing adsorption treatment on high-throughput and low-concentration gas components.

The present application provides an adsorption method of the above adsorber, which is simple to operate, improves the efficiency of adsorption and desorption and reduces operating costs.

The present application further provides an adsorption system including the above adsorber, reducing system pressure drop and improving the efficiency of adsorption and desorption.

In one aspect, the present application provides an adsorber including: a housing with a cavity therein; a plurality of spaced adsorption bed layers and a plurality of airflow distribution plates, located in the cavity; where the housing is further provided with a plurality of air inlets and air outlets, the air inlets are configured to respectively inject a gas to be adsorbed and a regeneration gas into the cavity, and the air outlets are configured to discharge an adsorbed gas and a desorbed gas;
an interval between two adjacent adsorption bed layers constitutes a channel, and the channel is communicated with the air inlet and the air outlet, respectively, with a width of the channel gradually decreasing along a direction from the air inlet toward the air outlet;
inlets of the plurality of airflow distribution plates are communicated with the air inlet, and outlets of the airflow distribution plates face the adsorption bed layers;
the airflow distribution plate has gradually decreasing aperture diameters from the inlets to the outlets.

Further, the plurality of adsorption bed layers are disposed at intervals along an axial or radial direction of the housing; where,
at least one of the air inlets is provided on the housing corresponding to the channel; and/or,
at least one of the air outlets is provided on the housing corresponding to the channel.

Further, the channel corresponding to the air inlet is different from the channel corresponding to the air outlet; and/or,
a partition plate is disposed in a middle of the channel corresponding to the air inlet.

Further, the adsorption bed layer has a thickness of 1 to 20 cm; and/or,
the airflow distribution plate has a thickness of 2 to 5 mm; and/or,
a ratio of the aperture diameter at the outlet of the airflow distribution plate to the aperture diameter at the inlet of the airflow distribution plate is 1:(2-5).

Further, a ratio of a width of the channel to the thickness of the adsorption bed layer is 1:(2-10).

Further, the adsorber is further provided with a pressure monitoring device, which is configured to monitor pressures of a first end face and a second end face of the adsorption bed layer oppositely disposed along a thickness direction of the adsorption bed layer; and/or,
the adsorber is further provided with a temperature monitoring device, which is configured to monitor temperatures of the first end face and the second end face of the adsorption bed layer oppositely disposed along the thickness direction the adsorption bed layer; and/or,
the housing is further provided with a liquid outlet for discharging condensate from the adsorption bed layer; and/or,
a thermal insulation layer is coated outside the housing.

In another aspect, the present application provides an adsorption method for the aforementioned adsorber, including the following steps:
(1) introducing a gas to be adsorbed through the air inlet into the cavity within the adsorber; after dispersion treatment by the airflow distribution plate on the gas to be adsorbed, introducing the gas to be adsorbed into the adsorption bed layer for adsorption treatment to obtain an adsorbed gas and a saturated adsorption bed layer; and extracting the adsorbed gas through the air outlet;
(2) performing vacuum pumping on the remaining gas in the adsorber until a pressure within the adsorber reaches −85 to −95 kPa;
(3) introducing a regeneration gas into the cavity within the adsorber through the air inlet; after dispersion treatment by the airflow distribution plate on the regeneration gas, performing regeneration treatment on the saturated adsorption bed layer to obtain a desorbed gas, condensate, and a regenerated adsorption bed layer; and extracting the desorbed gas through the air outlet; and
(4) performing cooling treatment on the regenerated adsorption bed layer.

Further, when the gas to be adsorbed is air and the desorbed gas is carbon dioxide, the adsorption bed layer includes an adsorbent, and a ratio of an adsorption amount of carbon dioxide to a mass of the adsorbent is 0.9 to 2 mmol/g; and/or,
the particle size distribution of the adsorbent is 0.3 to 1.5 mm, and the adsorbent includes solid amine adsorbent material; and/or,
in step (1), the inflow rate of the gas to be adsorbed is 200 to 300 Nm³/h; a temperature of the adsorption treatment is 20 to 40° C., and a time of the adsorption treatment is 100 to 120 min; and/or,
in step (3), the regeneration gas is water vapor, a temperature of the regeneration treatment is 80 to 120° C., and a time of the regeneration treatment is 10 to 30 min; the regeneration treatment includes direct steam purging regeneration treatment.

In a further aspect, the present application provides an adsorption system including the aforementioned adsorber.

Further, the adsorption system further includes a gas-to-be-adsorbed purifying and cooling device, an adsorption device, a regeneration gas generating device, and a separation device;
where the adsorption device includes at least one adsorber described above;
an outlet of the gas-to-be-adsorbed purifying and cooling device is communicated with the air inlet of the adsorber, and the air outlet of the adsorber is used to output the adsorbed gas;
an outlet of the regeneration gas generating device is communicated with the air inlet of the adsorber, and the air outlet of the adsorber is further communicated with an inlet of the separation device; and a gas phase outlet of the separation device is used to output a product gas, and a liquid phase outlet of the separation device is communicated with a return port of the regeneration gas generating device.

The present application provides an adsorber, a plurality of adsorption bed layers disposed at intervals, a plurality of air inlets and air outlets and channels with a special structure cooperates with each other, to allow airflow to enter a cavity of the adsorber through the plurality of air inlets, and sequentially pass through an airflow distribution plate and adsorption bed layers along a flow direction of the airflow, which can reduce the pressure drop of the bed layers and improve the efficiency of adsorption and desorption.

### BRIEF DESCRIPTION OF DRAWINGS

FIG. 1 is a schematic structural diagram of an adsorber in a specific implementation of the present application.

FIG. 2 is a schematic structural diagram of an adsorber in a specific implementation of the present application.

FIG. 3 is a schematic diagram of the adsorption system in a specific implementation of the present application.

FIG. 4 is a schematic diagram of the adsorption system in a specific implementation of the present application.

FIG. 5 is a graph of a variation of CO₂ concentration at an adsorption outlet over adsorption time.

FIG. 6 is a graph of a variation of CO₂ adsorption amount at an adsorption outlet over adsorption time.

FIG. 7 is a comparison diagram of regeneration rates under different regeneration treatment methods.

FIG. 8 is a graph of a variation of adsorption amount at different temperatures.

FIG. 9 is a graph of a variation of pressure in vacuum pumping over time.

FIG. 10 is a graph of a variation of temperature in cooling treatment over time.

### DESCRIPTION OF REFERENCE NUMERALS

1: housing; 2: first end face; 3: second end face; 4: adsorption bed layer; 5: pressure monitoring device; 6: airflow distribution plate; 7: air inlet; 8: air outlet; 9: temperature monitoring device; 10: liquid outlet; 11: vent pipe; 12: air inlet channel; 13: air outlet channel; 16: adsorbent inlet; 17: adsorbent replacement discharge outlet; 18: partition plate;
C1: gas-to-be-adsorbed purifying and cooling device; T1: adsorption device; K1: regeneration gas generating device; F1: separation device;
K01: water vapor generator; K02: flow rate adjusting unit; K03: steam boiler softened water treatment unit; F01: condenser; F02: gas-liquid separator; F03, T07: online infrared gas analyzer; F04: vacuum pump; F05: circulating water cooling unit; T01-T04: adsorber; T05: vacuum device; T06: blower; T08: automatic control system and instrumentation.

### DESCRIPTION OF EMBODIMENTS

To make the objectives, technical solutions, and advantages of the present application clearer, the technical solutions in the embodiments of the present application will be described clearly and completely below in conjunction with the embodiments of the present application. Obviously, the described embodiments are some but not all embodiments of the present application. Based on the embodiments of the present application, all other embodiments obtained by those skilled in the art without creative labor fall within the protection scope of the present application.

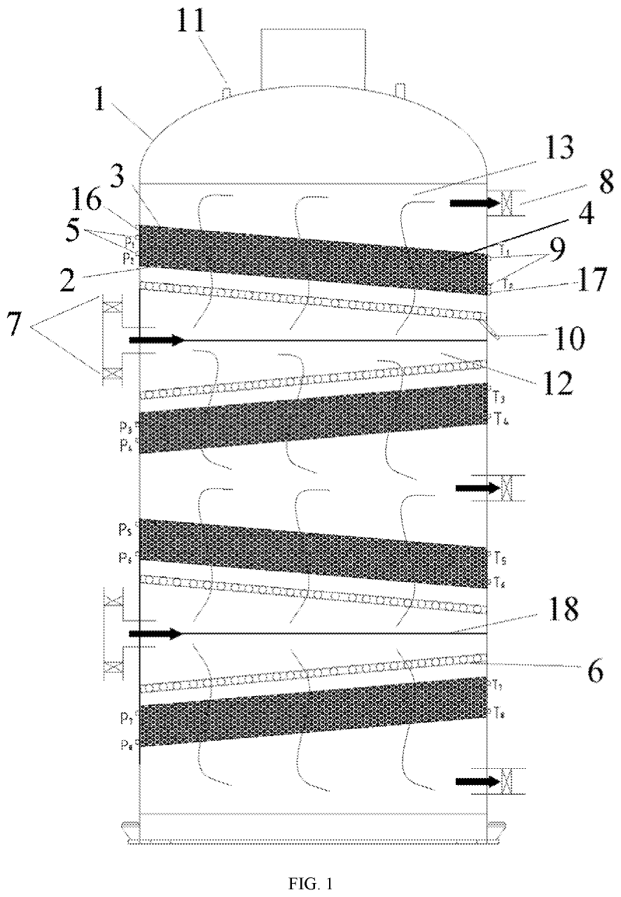

In one aspect, the present application provides an adsorber. FIG. 1 is a schematic structural diagram of an adsorber in a specific implementation of the present application. As shown in FIG. 1, the adsorber includes a housing 1 with a cavity therein, and a plurality of spaced adsorption bed layers 4 and a plurality of airflow distribution plates 6, located in the cavity. The housing 1 is further provided with a plurality of air inlets 7 and air outlets 8. The air inlets 7 are used to respectively inject a gas to be adsorbed and a regeneration gas into the cavity, and the air outlets 8 are used to discharge adsorbed gas and desorbed gas;
an interval between two adjacent adsorption bed layers 4 constitutes a channel, and the channel is respectively communicated with the air inlet 7 and the air outlet 8, with a width of the channel gradually decreasing along a direction from the air inlet toward the air outlet;
inlets of the plurality of airflow distribution plate 6 are communicated with the air inlets 7, and outlets of the airflow distribution plate face the adsorption bed layers 4; and
the airflow distribution plate 6 has gradually decreasing aperture diameters from the inlets to the outlets.

The term “a plurality of” of the present application refers to two or more, and the quantities for “a plurality of” may be identical or different; the present application does not limit the specific form of each part; where the housing 1 with the cavity inside may be circular or square.

A plurality of adsorption bed layers 4 are disposed at intervals within the cavity of the housing 1. A shape of the adsorption bed layer 4 is not limited in the present application and may be rectangular or trapezoidal. The adsorption bed layer 4 is filled with an adsorbent and provided with a layer for supporting along a thickness direction of the adsorption bed layer 4. The layer for supporting blocks the adsorbent with the minimum particle size while allowing gas to pass through smoothly. In an implementation, the layer for supporting may be a fabric or in a plate-like structure; the airflow enters the plurality of adsorption bed layers 4 for adsorption or regeneration treatment, improving the efficiency of adsorption and desorption.

The airflow distribution plate 6 can distribute and collect the airflow. Small holes are uniformly arranged on the airflow distribution plate 6 to evenly distribute the airflow into the adsorption bed layer, reducing pressure drop of the bed layer and preventing gas concentration in specific regions, and at the same time, filtering impurities from the gas to be adsorbed, thereby improving the efficiency of adsorption and desorption.

The housing 1 is further provided with a plurality of air inlets 7 and air outlets 8, through which the gas may simultaneously enter or exit the cavity of the adsorber. The air inlet 7 is used to respectively inject the gas to be adsorbed and the regeneration gas into the cavity, and the air outlets 8 are used to respectively discharge the adsorbed gas and desorbed gas. It can be understood that when the gas to be adsorbed is injected into the cavity, the adsorbed gas is discharged, and when the regeneration gas is injected into the cavity, the desorbed gas is discharged.

The interval between two adjacent adsorption bed layers is respectively communicated with the air inlet and the air outlet. Specifically, the channel communicated with the air inlet 7 is an air inlet channel 12, through which gas enters the adsorption bed layer 4, and the channel communicated with the air outlet 8 is an air outlet channel 13, through which gas exits the adsorption bed layer. The channel has a width gradually decreasing along a flow direction of the airflow from the air inlet toward the air outlet. As gas enters the channel via the air inlet, a cross-sectional area of the channel narrows from near the inlet to far from the inlet, and a flow rate of the airflow at the corresponding cross-sections keeps consistent, such that the airflow is distributed uniformly by efficiently facilitating the airflow distribution plate.

After entering the cavity within the adsorber through inlets 7, the airflow flows through the inlets of the airflow distribution plate 6. Through the dispersion treatment by the airflow distribution plate, the airflow is dispersed and distributed uniformly, then exits through the outlets of airflow distribution plate and enters the adsorption bed layer 4. The airflow distribution plate 6 has gradually decreasing aperture diameters from the inlets to the outlets, and the apertures are in a truncated conical shape, the airflow can be effectively distributed, and the resistance of the airflow can be reduced to reduce the pressure drop of the bed layer.

In the adsorber provided by the present application, the plurality of adsorption bed layers disposed at intervals, the plurality of air inlets and air outlets, and the channels special structures cooperate with each other to allow the airflow to enter the cavity within the adsorber through the plurality of air inlets, sequentially pass through the airflow distribution plates and adsorption bed layers along the flow direction of the airflow, which can reduce the pressure drop of the bed layers and improve the efficiency of adsorption and desorption.

In an implementation, the plurality of adsorption bed layers 4 are disposed at intervals along an axial or radial direction of the housing 1; where at least one air inlet 7 is provided on the housing corresponding to the channel, and at least one air outlet 8 is provided on the housing corresponding to the channel.

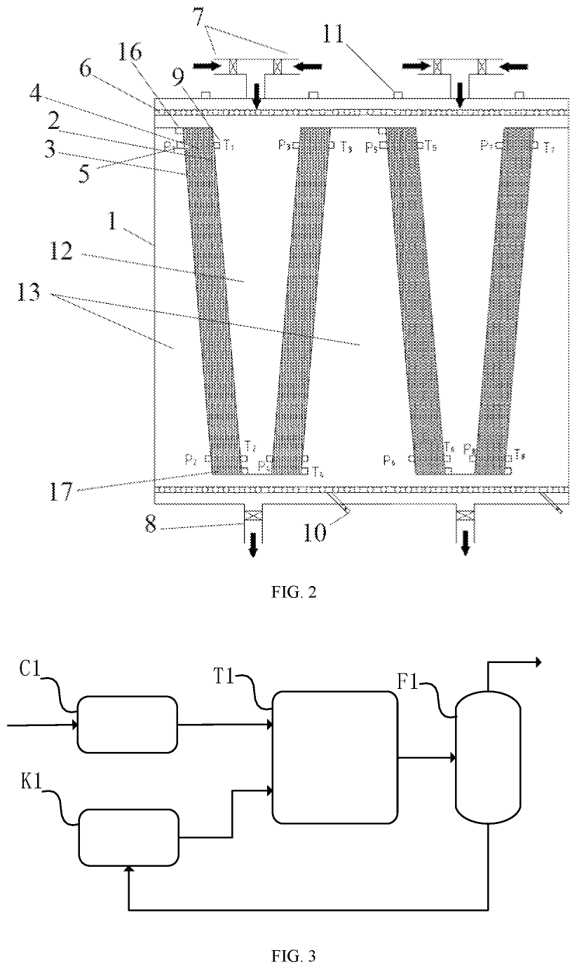

The present application does not limit the arrangement direction of the adsorption bed layers 4. The plurality of adsorption bed layers 4 may be disposed at intervals along the radial direction of the housing 1 (as shown in FIG. 1) or the axial direction of the housing 1 (as shown in FIG. 2). In one specific implementation, at least one air inlet 7 is provided on the housing 1 corresponding to the channel, so that the airflow may enter the sealed housing 1 through the air inlet 7, and the gas to be adsorbed and the regeneration gas may share a single air inlet, or two parallel air inlets may be further subdivided; In another specific implementation, at least one air outlet 8 is provided on the housing 1 corresponding to the channel, allowing airflow to exit the sealed housing 1 through the air outlet 8. The adsorbed gas and desorbed gas may share a single air outlet, or two parallel air outlets may be further subdivided.

Furthermore, the channel corresponding to air inlet 7 is different from the channel corresponding to the air outlet 8.

It can be understood that the channel corresponding to air inlet 7 is different from the channel corresponding to the air outlet 8, which means that each channel can only correspond to either an air inlet or an air outlet, so that the airflow passes through at least one adsorption bed layer in the passages of entering and exiting the adsorber, thereby improving the efficiency of adsorption and desorption.

In one specific implementation, a partition plate 18 is positioned in the middle of the channel corresponding to the air inlet.

It can be understood that partition plate 18 added in the middle of the inlet channel enables the gas to be adsorbed to be evenly divided into two parts when entering the air inlet channel, which facilitates further uniform distribution of the air flow, reduces pressure drop of the bed layer, and improves adsorption and regeneration efficiency.

Specifically, the adsorption bed layer has a thickness of 1 to 20 cm.

The thickness of the adsorption bed layer refers to an average length of a path of the airflow passing through the adsorption bed layer. It can be understood that the thickness of the adsorption bed layer is closely related to the resistance suffered by the airflow passing through the adsorption bed layer. The applicant found that when the adsorption bed layer 4 has a thickness of 1 to 20 cm, it can further reduce the pressure drop of the bed layer and improve the mass transfer efficiency while ensuring the efficiency of adsorption and desorption.

In a specific implementation of the present application, the thickness of the airflow distribution plate is 2 to 5 mm; and a ratio of the aperture diameter at the outlet of the airflow distribution plate to the aperture diameter at the inlet of the airflow distribution plate is 1:(2-5).

It can be understood that the airflow distribution plate has a plate-like structure with a certain thickness and distributed with small apertures. Due to the gradual reduction of the aperture diameter from the inlet to the outlet, the aperture is in a truncated conical shape. The research conducted by the applicant indicates that when the thickness of the airflow distribution plate is 2 to 5 mm and the ratio of the aperture diameter at the outlet of the airflow distribution plate to the aperture diameter at the inlet of the airflow distribution plate is 1:(2-5), the airflow resistance can be further reduced, achieving uniform distribution of the airflow and further lowering the pressure drop of the bed layer.

Furthermore, a ratio of the width of the channel to the thickness of the adsorption bed layer 4 is 1:(2-10).

Since the channel gradually widens along the flow direction of the airflow, the width of the channel refers to an average width. The applicant found that when the ratio of the width of the channel to the thickness of the adsorption bed layer 4 is 1:(2-10), it facilitates that the airflow efficiently passes through the adsorption bed layer, the pressure drop of the bed layer is reduced and the mass transfer efficiency is improved.

In a specific implementation, the adsorber is further provided with a pressure monitoring device 5 (e.g., P₁, P₂, P₃, P₄, P₅, P₆, P₇ and P₈, as shown in FIG. 1 and FIG. 2), which is used to monitor pressures of a first end face 2 and a second end face 3 of the adsorption bed layer 4 oppositely disposed along a thickness direction of the adsorption bed layer 4.

The specific arrangement manner of the pressure monitoring device 5 is not limited in the present application. The pressure monitoring device 5 may be arranged on the housing 1 or not, provided that it can monitor and output the pressures of the first end face 2 and the second end face 3 of the adsorption bed layer 4 oppositely disposed along the thickness direction.

In another specific implementation, the adsorber is further provided with a temperature monitoring device 9 (e.g., T₁, T₂, T₃, T₄, T₅, T₆, T₇ and T₈, as shown in FIG. 1 and FIG. 2), which is used to monitor temperatures of the first end face 2 and the second end face 3 of the adsorption bed layer 4 oppositely disposed along the thickness direction of the adsorption bed layer 4.

The specific arrangement manner of the temperature monitoring device 9 is not limited by the present application. The temperature monitoring device 9 may be arranged on the housing 1 or not, provided that it can monitor and output the temperatures of the first end face 2 and second end face 3 of adsorption bed layer 4 oppositely disposed along the thickness direction of the adsorption bed layer 4.

In a further specific implementation, the housing 1 is further provided with a liquid outlet 10 for discharging condensate from the adsorption bed layer 4.

It can be understood that condensate may be generated during the adsorption or desorption processes. Therefore, the liquid outlet 10 disposed on the housing 1 allows discharging the condensate in the adsorption bed layer 4 and the housing 1, thereby further improving the mass transfer efficiency and reducing the pressure drop of the bed layer.

Furthermore, a thermal insulation layer is further coated outside the housing 1. By providing the thermal insulation layer outside of the housing 1, it is beneficial to maintain the temperature within the adsorber constant, further improve the efficiency of adsorption and desorption and maintain the stability of the reaction.

In an implementation, the housing 1 is further provided with an adsorbent filling inlet 16 and an adsorbent replacement outlet 17. The adsorbent filler is first naturally filled into an upper part of the adsorption bed layer 4 through the adsorbent filling inlet 16, followed by filling assisted by pressurized air. When the adsorbent is needed to be replaced, the adsorbent filler is discharged and replaced through the adsorbent replacement outlet 17. A vent pipe 11 is also provided on an upper part of the housing 1, which helps adjust the pressure within the adsorber and so on.

In another aspect, the present application also provides an adsorption method of the aforementioned adsorber, including the following steps:
(1) introducing a gas to be adsorbed into the cavity within the adsorber through the air inlet; after dispersion treatment by the airflow distribution plate on the gas to be adsorbed, introducing the gas to be adsorbed into the adsorption bed layer for adsorption treatment to obtain an adsorbed gas and a saturated adsorption bed layer; and extracting the adsorbed gas through an air outlet;
(2) performing vacuum pumping on the remaining gas in the adsorber until a pressure within the adsorber reaches −85 to −95 kPa;
(3) introducing a regeneration gas into the cavity within the adsorber through the air inlet; after dispersion treatment by the airflow distribution plate on the regeneration gas, performing regeneration treatment on the saturated adsorption bed layer to obtain a desorbed gas, condensate, and a regenerated adsorption bed layer; and extracting the desorbed gas through the air outlet; and
(4) performing cooling treatment on the regenerated adsorption bed layer.

The adsorption method provided by the present application is applicable to any process directly utilizing a solid adsorbent for gas adsorption. Specifically: In step (1), the gas to be adsorbed is introduced into the cavity within the adsorber through the inlet and enters the adsorption bed layer for adsorption treatment after being dispersed by the airflow distribution plate, to remove the components to be adsorbed from the gas to be adsorbed. It can be understood that gas analyzers are also disposed at the air inlet and air outlet of the adsorber to detect concentrations of the components to be adsorbed in the gas to be adsorbed, such that inlet concentration and outlet concentration are obtained respectively. When the outlet concentration equals the inlet concentration, it indicates that the adsorbent in the adsorption bed layer has reached adsorption saturation. At this point, adsorption treatment is stopped, the adsorbed gas from which the components to be adsorbed has been separated and the saturated adsorption bed layer are obtained. The adsorbed gas is extracted through the air outlet to remove from the adsorber;

In step (2), vacuum pumping is performed on the remaining gas in the adsorber until the pressure within the adsorber reaches −85 to −95 kPa, which is beneficial to improve the regeneration efficiency and reduce the cost.

In step (3), the regeneration gas is introduced through the air inlet into the cavity within the adsorber, and is dispersed by the airflow distribution plate; and then regeneration treatment is performed on the saturated adsorption bed layer, so as to desorb the accumulated components to be adsorbed in the saturated adsorption bed layer. It can be understood that the air outlet of the adsorber is also connected with a separation device, a gas analyzer, etc., for separating the desorbed gas and detecting a flow rate of the desorbed gas. When the flow rate of the desorbed gas detected is 0 L/min, it indicates that all components to be adsorbed in the adsorption bed layer have been completely desorbed. At this point, the regeneration treatment is stopped to obtain a desorbed gas rich in the components to be adsorbed, condensate, and a regenerated adsorption bed layer. The desorbed gas is extracted via the air outlet and exits the adsorber, while the condensate is discharged through the liquid outlet.

In step (4), the cooling treatment is performed on the regenerated adsorption bed layer, which is beneficial to improve the efficiency of the next adsorption treatment. Step (1) to step (4) constitute a cycle of the adsorption method provided by the present application. Following step (4), step (1) is directly performed to initiate the next round of adsorption treatment.

The adsorption method of the above adsorber provided by the present application is simple and practical, helps reduce the pressure drop of the bed layer and improve the gas mass transfer efficiency, and enables infinite regeneration of the adsorption bed layer without consuming auxiliary materials during the treatment, thereby improving the efficiency of adsorption and regeneration and lowering cost.

Specifically, when the gas to be adsorbed is air and the desorbed gas is carbon dioxide, the adsorption bed layer includes an adsorbent, and a ratio of an adsorption amount of carbon dioxide to a mass of the adsorbent is 0.9 to 2 mmol/g; a particle size distribution of the adsorbent is 0.3 to 1.5 mm, and the adsorbent includes a solid amine adsorbent material. In step (1), an inflow rate of the gas to be adsorbed is 200 to 300 Nm³/h; a temperature of the adsorption treatment is 20 to 40° C., and a time of the adsorption treatment is 100 to 120 min. In step (3), the regeneration gas is water vapor, a temperature of the regeneration treatment is 80 to 120° C., and a time of the regeneration treatment is 10 to 30 min; the regeneration treatment includes direct steam purging regeneration treatment.

Taking direct air capture of carbon dioxide as an example, the gas to be adsorbed is air, and the component to be adsorbed and the desorbed gas are carbon dioxide; a ratio of the adsorption amount of carbon dioxide to a mass of the adsorbent is 0.9 to 2 mmol/g; the particle size distribution of the adsorbent is 0.3 to 1.5 mm, and the adsorbent includes solid amine adsorbent material, specifically, the adsorbent is an amino-functionalized solid amine adsorbent; in step (1), the inflow rate of the gas to be adsorbed is 200 to 300 Nm³/h; the temperature of the adsorption treatment is 20 to 40° C., and the time of the adsorption treatment is 100 to 120 min; in step (3), the regeneration gas is water vapor, the temperature of the regeneration treatment is 80 to 120° C., and the time of the regeneration treatment is 10 to 30 min; the regeneration treatment includes direct steam purging regeneration treatment. The applicant found that the above parameters help further improve the efficiency of the adsorber in capturing carbon dioxide in the air.

In a further aspect, the present application also provides an adsorption system including the aforementioned adsorber.

By the adsorption system including the aforementioned adsorber, the pressure drop of the bed layer can be reduced, the efficiency of adsorption and regeneration can be enhanced, and the cost can be reduced.

Specifically, FIG. 3 is a schematic diagram of an adsorption system in a specific implementation of the present application. As shown in FIG. 3, the adsorption system further includes a gas-to-be-adsorbed purifying and cooling device C1, an adsorption device T₁, a regeneration gas generating device K1, and separation device F1;
where the adsorption device T₁ includes at least one of adsorber;
an outlet of the gas-to-be-adsorbed purifying and cooling device C1 is communicated with an air inlet of the adsorber, and an air outlet of the adsorber is used to output an adsorbed gas; and
an outlet of the regeneration gas generating device K1 is communicated with the air inlet of the adsorber, and the air outlet of the adsorber is further communicated with an inlet of the separation device F1; a gas phase outlet of the separation device F1 is used to output a product gas, and a liquid phase outlet of the separation device F1 is communicated with a return port of the regeneration gas generating device K1.

In the description of the present application, it should be noted that unless otherwise explicitly specified and limited, the terms “install”, “communicate”, and “connect” should be interpreted in a broad sense, for example, they may refer to a fixed connection, a connection via an intermediary medium, an internal communication between two components, or an interactive relationship between two components. Those skilled in the art can understand the specific meanings of the above terms in the present application based on specific situations.

The present application does not limit the specific implementation form of each unit, provided that: the gas-to-be-adsorbed purifying and cooling device C1 can filter impurities from the gas to be adsorbed and cooling it; the adsorption device T1 includes at least one of the aforementioned adsorbers, with each adsorber connected in parallel or in series; the regeneration gas generating device K1 can generate the regeneration gas; and the separation device F1 can achieve the separation of the components to be adsorbed in the desorbed gas from the regeneration gas.

Specifically, the inlet of the gas-to-be-adsorbed purifying and cooling device C1 refers to the inlet of the adsorption system. The gas to be adsorbed enters the gas-to-be-adsorbed purifying and cooling device C1 through the inlet of the gas-to-be-adsorbed purifying and cooling device C1, where it undergoes filtering for purification and cooling, and followed by exiting through the outlet of the gas-to-be-adsorbed purifying and cooling device C1, the gas enters the adsorption device T1 through the air inlet of the adsorber and is performed adsorption treatment within the adsorption device T1. Upon completion of adsorption treatment, adsorbed gas and a saturated adsorption bed layer are obtained. The adsorbed gas is extracted through the air outlet of the adsorber and leave from the adsorption system. The outlet of the regeneration gas generating device K1 is also connected to the air inlet of the adsorber. Regeneration gas produced at the outlet of the regeneration gas generating device K1 enters the adsorber through the air inlet of the adsorber, and then perform regeneration treatment on the saturated adsorption bed layer by desorbing and sucking out the component to be adsorbed in the saturated adsorption bed layer, obtaining a regenerated adsorption bed layer and desorbed gas. The desorbed gas is extracted through the air outlet of the adsorber and enters into the separation device F1 via the inlet of the separation device F1, where the component to be adsorbed is separated from the regeneration gas, obtaining a product gas and regeneration circulating liquid. The product gas exits through the gas phase outlet of the separation device F1 to output the product gas, and the regeneration circulating liquid is communicated with a return port of the regeneration gas generating device K1 to recover the regeneration gas.

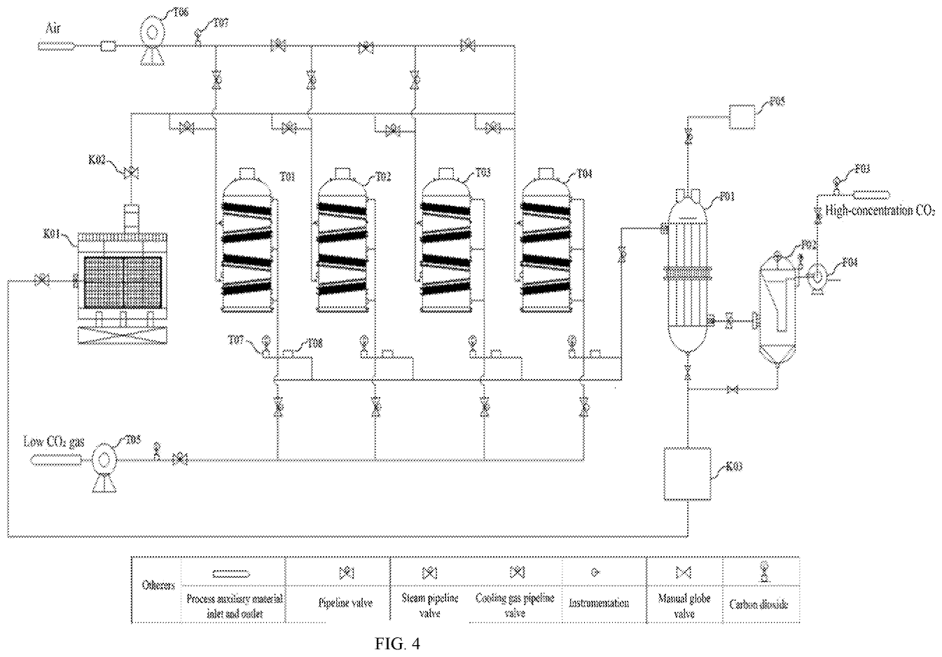

FIG. 4 is a schematic diagram of an adsorption system in a specific implementation of the present application. As shown in FIG. 4, when the adsorption system is used to capture carbon dioxide directly from air, a regeneration gas generating device includes a water vapor generator K01, a flow rate adjusting unit K02, etc., where the water vapor generator K01 is used to heat room-temperature feed water until boiling to produce sufficient water vapor for heating the adsorbent. The flow rate adjusting unit K02 primarily includes an opening adjustment valve and a flow meter, and the flow rate of water vapor is adjusted via a PID (Proportional-Integral-Derivative) control system;

A separation device includes a condenser F01, a gas-liquid separator F02, an online infrared gas analyzer F03, a vacuum pump F04, and a circulating water cooling unit F05, where the condenser F01 is used to condense the mixed gas of desorbed carbon dioxide and water vapor to a specific temperature and remove most of the water; the gas-liquid separator F02 is used to separate carbon dioxide gas from water; the online infrared gas analyzer F03 is used to detect the purity of the separated carbon dioxide product gas; the vacuum pump F04 helps extract carbon dioxide product gas separated from the liquid; and the circulating water cooling unit F05 is used to circulate and cool the condenser F01 to lower the temperature.

An adsorption device includes four parallel adsorbers T01-T04, a vacuum device T05, a blower T06, an online infrared gas analyzer T07, an automatic control system and instrumentation T08, etc. Where the vacuum device T05 is used to extract residual air from the adsorbers and promptly extract residual gases during desorption and regeneration processes to accelerate the efficiency of adsorption and regeneration; the blower T06 is used to introduce air into the adsorbers and can overcome sufficient frictional drag; the online infrared gas analyzer T07 is used to monitor concentration changes at the air inlet and air outlet of the adsorber in real time; the automatic control system and instrumentation T08 is used to perform timely flow adjustment, where all valves are connected to a programmable logic controller (PLC), and the operation of the entire system is controlled by the controller of the PLC;

In an implementation, the adsorption system further includes a steam boiler softened water treatment unit K03 for treating discharging liquid from a condensation section at a bottom of an adsorption tower. Specifically, a liquid outlet of the adsorber and a liquid phase outlet of the gas-liquid separator are connected to an inlet of the steam boiler softened water treatment unit, while an outlet of the steam boiler softened water treatment unit is connected to a return port of the water vapor generator.

The following detailed description of the adsorber provided by the present application is illustrated through specific implementations.

### Example 1

This example uses the adsorber shown in FIG. 1 with four adsorption bed layers axially disposed at intervals, two air inlets, three air outlets and four airflow distribution plates. The adsorption bed layer has a thickness of 10 cm. A ratio of a width of a channel to a thickness of the thickness of the adsorption bed layer is 1:2; an airflow distribution plate has a thickness of 3 mm; and a ratio of an aperture diameter at an outlet of the airflow distribution plate to an aperture diameter at an inlet of the airflow distribution plate is 1:3.

This example performs adsorption treatment on carbon dioxide in air, a concentration of carbon dioxide in air is 400 ppm, and the adsorption treatment includes the following steps:
(1) introducing air into a cavity of an adsorber through an air inlet at an inflow rate of 260 Nm³/h; after dispersion treatment by the airflow distribution plate on the air, introducing the air into an adsorption bed layer for adsorption treatment to obtain an adsorbed air and a saturated adsorption bed layer; and extracting the adsorbed air through the air outlet; where the adsorbent provided within the adsorption bed layer is an amino-functionalized solid amine adsorbent, with a particle size of 0.6 mm, a temperature of the adsorption treatment is 20° C. and a time of the adsorption treatment is 120 min;
(2) performing vacuum pumping on the residual gas within the adsorber; where a time of the vacuum pumping is 5 min and an internal pressure within the adsorber is-95 kPa;
(3) introducing water vapor into the cavity of the adsorber through the air inlet at an inflow rate of 1 Nm³/h; performing regeneration treatment on the saturated adsorption bed layer after dispersing via the airflow distribution plate to obtain carbon dioxide, condensate, and the regenerated adsorption bed layer; and extracting carbon dioxide through the air outlet; where regeneration treatment adopts direct steam purging, a temperature of the regeneration treatment is 120° C. and a time of the regeneration treatment is 15 min; and
(4) performing cooling treatment on the regenerated adsorption bed layer by introducing air into the cavity of the adsorber; where a temperature of the cooling treatment is room temperature and a time is 10 min.

### Example 2

This example differs from Example 1 in that: in step (1), the time of the adsorption treatment is 60 min.

### Example 3

This example differs from Example 1 in that: in step (1), the time of the adsorption treatment is 180 min.

### Example 4

This example differs from Example 1 in that: in step (1), the temperature of the adsorption treatment is 10° C.

### Example 5

This example differs from Example 1 in that: in step (3), the regeneration treatment employs steam-assisted heat exchange.

### Example 6

This example differs from Example 1 in that: the adsorber as shown in FIG. 2 is used, with four adsorption bed layers axially disposed at intervals; two air inlets, two air outlets and two airflow distribution plates; the adsorption bed layer has the thickness of 10 cm; and the ratio of the width of the channel to the thickness of the adsorption bed layer is 1:2.

### Example 7

This example differs from Example 1 in that: the adsorption bed layer has a thickness of 20 cm.

### Example 8

This example differs from Example 1 in that: the ratio of the width of the channel to the thickness of the adsorption bed layer is 1:10.

### Comparative Example 1

This comparative example differs from Example 1 in that: there is one adsorption bed layer, one air inlet, one air outlet, and one distribution plate; and the adsorption bed layer has a thickness of 40 cm.

### Test Example 1

The adsorbed air of the examples and comparative example is detected by an online infrared gas analyzer: average CO₂ adsorption amount=(inlet concentration−outlet concentration)× airflow rate×adsorption time/adsorbent mass;
a calculation formula of the CO₂ capture rate is:

$$CCR = \frac{{\int }_{0}^{t} total C \text{?} ( L ) {Q}_{purge} dt}{{\int }_{0}^{t} total {C}_{feed ,} \text{?} {Q}_{feed} dt} ;$$

$$\text{?} \text{indicates text missing or illegible when filed}$$

CCR represents a CO₂ capture rate, with a unit of %; total C_{CO2} represents an average CO₂ concentration at the air outlet during adsorption, and total C_{feed,CO2} represents an average CO₂ concentration at the air inlet during adsorption, with a unit of ppm; and Q_{feed} represents a flow rate at an inlet during adsorption, and Q_{purge} represents a flow rate at an outlet during adsorption, with a unit of L/min;
where the pressure drop of the bed layer is calculated using the classical Ergun formula:

$$Δ p \text{?} = [ 150 \frac{{( 1 - ε )}^{2}}{{ε}^{3}} \frac{μ u}{{d}_{p}^{2}} + 1.75 \frac{1 - ε}{{ε}^{3}} \frac{p {μ}^{2}}{{d}_{p}} ] \times Z$$

$$\text{?} \text{indicates text missing or illegible when filed}$$

Z represents the thickness of the adsorption bed layer, with a unit of cm; ε represents a porosity of the adsorption bed layer, with a unit of %; dₚ represents an average particle size of the adsorbent, with a unit of mm; u represents an apparent flow velocity of the adsorption bed layer, with a unit of m/s; ρ represents a gas density, with a unit of kg/m³; and μ represents a gas viscosity, with a unit of Pa·s.

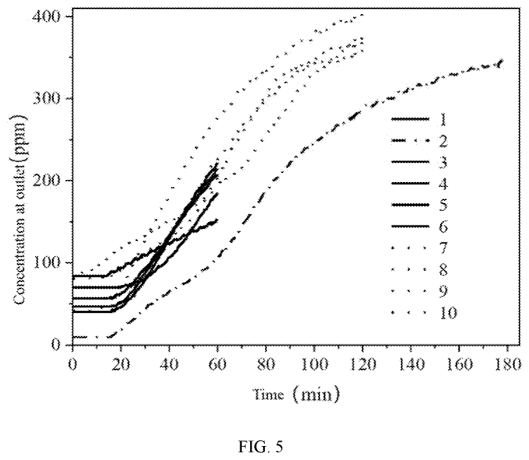

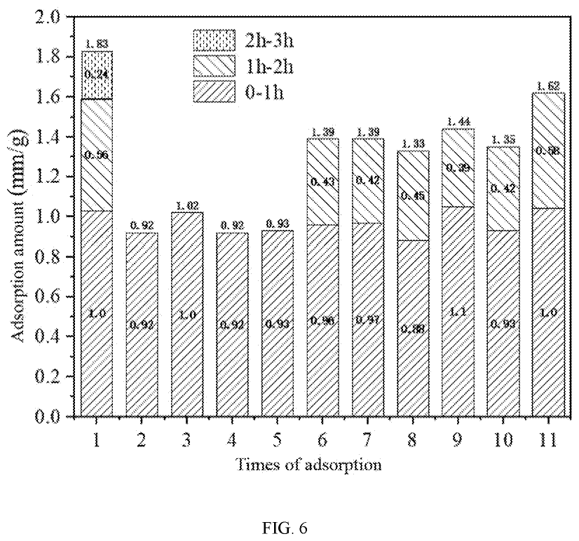

The measured results are shown in FIGS. 5 and 6 and Table 1.

FIG. 5 is a graph of a variation of CO₂ concentration at an adsorption outlet over adsorption time, where Legends 1 and 3 to 6 represent repeated experiments with an adsorption time of 60 min, Legend 2 represents an adsorption time of 180 min, and Legends 7 to 10 represent repeated experiments with an adsorption time of 120 min. FIG. 6 is a graph of a variation of CO₂ adsorption amount at an adsorption outlet over adsorption time. As can be seen from the figure, when the adsorption time is 60 min, the adsorption amount ranges from 0.88 to 1.1 mmol/g; when the adsorption time is 120 min, the adsorption amount ranges from 1.35 to 1.62 mmol/g; and meanwhile, when the adsorption time reaches 180 min, the adsorption amount increases by only 13%. When the adsorption time is 100 to 120 min, the adsorption amount already accounts for more than 80% of the saturation adsorption amount. Therefore, the present application recommends an adsorption time of 100 to 120 min to ensure the adsorption efficiency while reducing operating costs.

TABLE 1

| | | Average CO₂ | Average CO₂ | CO₂ | |
|---|---|---|---|---|---|
| | Pressure | concentration | adsorption | capture | Regeneration |
| Group | drop/kPa | at outlet/ppm | amount/mmol · g⁻¹ | rate/% | time/min |
| Example 1 | 9.75 | 211.4 | 1.44 | 25 | 15 |
| Example 2 | 9.75 | 99.35 | 0.97 | 33 | 10 |
| Example 3 | 9.75 | 237 | 1.83 | 21 | 30 |
| Example 4 | 9.75 | 211.4 | 1.6 | 25 | 15 |
| Example 5 | 9.75 | 211.4 | 1.44 | 25 | 90 |
| Example 6 | 9.75 | 211.4 | 1.44 | 25 | 15 |
| Example 7 | 19.5 | 211.4 | 1.44 | 25 | 15 |
| Example 8 | 10 | 211.4 | 1.44 | 25 | 15 |
| Comparative | 39 | 211.4 | 1.44 | 25 | 15 |
| Example 1 | | | | | |

As can be seen from Table 1, compared to Comparative Example 1, the adsorber and adsorption method provided by the present application can effectively reduce the pressure drop of the bed layer while improving the adsorption and regeneration efficiency of carbon dioxide.

### Test Example 2

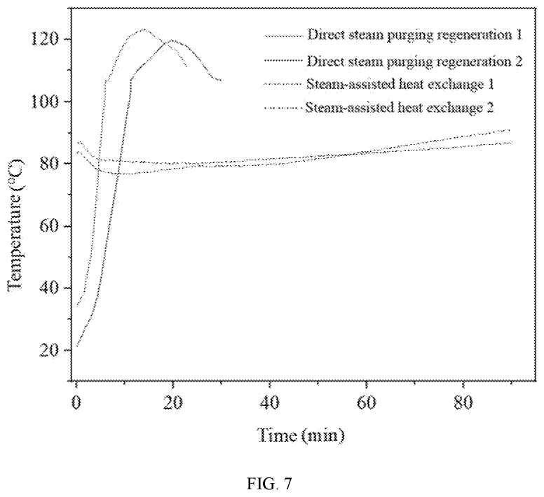

A variation of temperature in the adsorption bed layer during regeneration treatment in Examples 1 and 5 is measured by a temperature monitoring device, with results shown in FIG. 7.

FIG. 7 is a comparison diagram of regeneration rates under different regeneration treatment methods, where both steam-assisted heat exchange regeneration and direct steam purging regeneration are repeated twice. As can be seen from FIG. 7, the average temperature of the steam-assisted heat exchange in Example 5 is about 82° C., with a longer regeneration time of 90 min. In Example 1, the average temperature of the direct steam purging regeneration is approximately 100° C., with a regeneration time of about 25 min. Therefore, direct steam purging regeneration can significantly enhance the regeneration rate, shorten the regeneration time, and improve the operating efficiency of the adsorber.

### Test Example 3

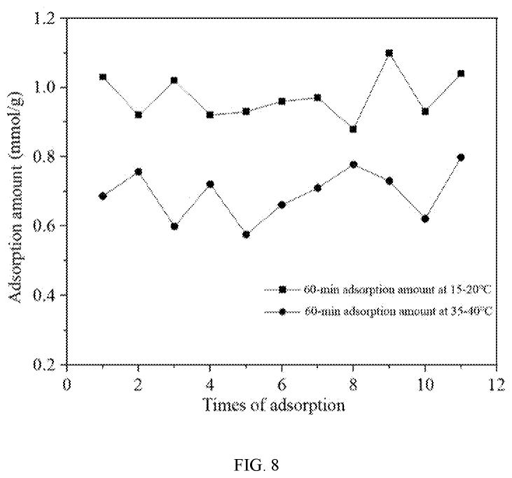

The adsorbed air of Example 1 and Example 4 is detected by an online infrared gas analyzer. The temperature of the adsorption bed layer during the adsorption treatment is monitored by a temperature monitoring device to obtain FIG. 8.

FIG. 8 is a graph of a variation of adsorption amount at different temperatures. In Example 4, an average temperature during the adsorption process is 35 to 40° C., and the average adsorption amount over 60 minutes is about 0.65 mmol/g. In Example 1, the average temperature during the adsorption process is 15 to 20° C., and the average adsorption amount over 60 minutes is about 0.97 mmol/g. It can be seen that a low adsorption temperature facilitates the adsorption process. Therefore, when the adsorption temperature is 10 to 20° C., it is beneficial to ensure the high-efficiency adsorption.

### Test Example 4

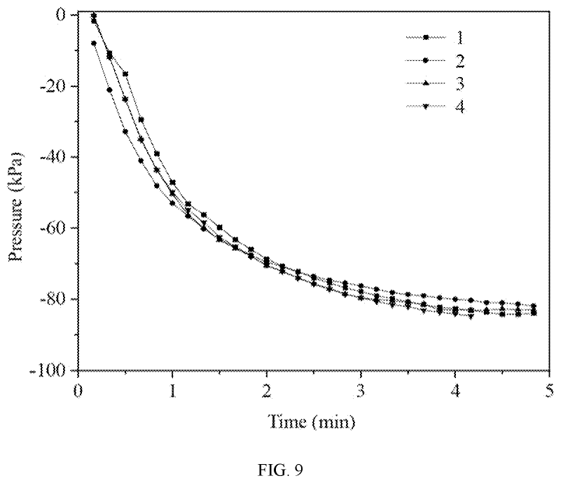

A pressure monitoring device is used to monitor pressure changes within the adsorber during the vacuum pumping in step (2) of Example 1, and the results are shown in FIG. 9.

FIG. 9 is a graph of a variation of pressure in vacuum pumping over time. As can be seen from the figure, the pressure of the adsorber can be reduced to the target value within 5 to 10 min.

### Test Example 5

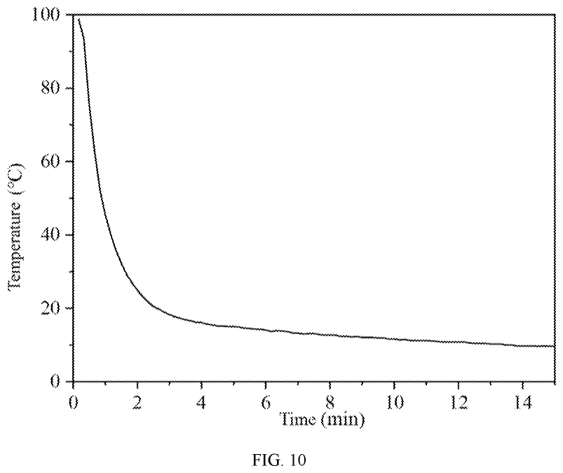

A temperature monitoring device is used to measure the temperature change in the adsorption bed layer during the cooling treatment in step (4) of Example 1, and the results are shown in FIG. 10.

FIG. 10 is a graph of a variation of temperature in cooling treatment over time. The temperature of the bed layer can be reduced to room temperature in about 10 min by using air cooling, improving the cooling efficiency, reducing energy consumption during regeneration, significantly reducing the regeneration cooling operation time of the adsorber, and shortening the adsorption/desorption cycle time.

Finally, it should be noted that the above embodiments are used to illustrate the technical solutions of the present application and are not intended to limit them. Although the present application has been described in detail with reference to the foregoing embodiments, those skilled in the art should understand that modifications to the technical solutions described in the foregoing embodiments, or equivalent replacements of some or all technical features, may still be made. Such modifications or replacements do not cause the corresponding technical solutions to deviate from the scope of the technical solutions of the embodiments of the present application.

What is claimed is:

1. An adsorber, comprising: a housing with a cavity therein; and a plurality of spaced adsorption bed layers and a plurality of airflow distribution plates, located in the cavity; wherein the housing is further provided with a plurality of air inlets and air outlets, the air inlets are configured to respectively inject a gas to be adsorbed and a regeneration gas into the cavity, and the air outlets are configured to discharge an adsorbed gas and a desorbed gas;
the adsorption bed layers are disposed obliquely;
an interval between two adjacent adsorption bed layers constitutes a channel, and the channel is communicated with the air inlet and the air outlet, respectively, with a width of the channel gradually decreasing along a direction from the air inlet toward the air outlet; and a ratio of the width of the channel to a thickness of the adsorption bed layer is 1:(2-10);
inlets of the plurality of airflow distribution plates are communicated with the air inlets, and outlets of the airflow distribution plate face the adsorption bed layers; and
the airflow distribution plate has gradually decreasing aperture diameters from the inlets to the outlets.

2. The adsorber according to claim 1, wherein the plurality of adsorption bed layers are disposed at intervals along an axial or radial direction of the housing; and at least one of the air inlets is provided on the housing corresponding to the channel.

3. The adsorber according to claim 2, wherein at least one of the air outlets is provided on the housing corresponding to the channel.

4. The adsorber according to claim 3, wherein the channel corresponding to the air inlet is different from the channel corresponding to the air outlet.

5. The adsorber according to claim 2, wherein a partition plate is disposed in a middle of the channel corresponding to the air inlet.

6. The adsorber according to claim 1, wherein the adsorption bed layer has a thickness of 1 to 20 cm.

7. The adsorber according to claim 1, wherein the airflow distribution plate has a thickness of 2 to 5 mm.

8. The adsorber according to claim 1, wherein a ratio of the aperture diameter at the outlet of the airflow distribution plate to the aperture diameter at the inlet of the airflow distribution plate is 1:(2-5).

9. The adsorber according to claim 1, wherein the adsorber is further provided with a pressure monitoring device, which is configured to monitor pressures of a first end face and a second end face of the adsorption bed layer oppositely disposed along a thickness direction of the adsorption bed layer.

10. The adsorber according to claim 1, wherein the adsorber is further provided with a temperature monitoring device, which is configured to monitor temperatures of a first end face and a second end face of the adsorption bed layer oppositely disposed along a thickness direction of the adsorption bed layer.

11. The adsorber according to claim 1, wherein the housing is further provided with a liquid outlet for discharging condensate in the adsorption bed layer.

12. The adsorber according to claim 1, wherein a thermal insulation layer is coated outside the housing.

13. An adsorption method of the adsorber according to claim 1, comprising the following steps:
(1) introducing the gas to be adsorbed into the cavity in the adsorber through the air inlet; after dispersion treatment by the airflow distribution plate on the gas to be adsorbed, introducing the gas to be adsorbed into the adsorption bed layer for adsorption treatment to obtain an adsorbed gas and a saturated adsorption bed layer; and extracting the adsorbed gas through the air outlet;
(2) performing vacuum pumping on the remaining gas in the adsorber until a pressure within the adsorber reaches −85 to −95 kPa;
(3) introducing a regeneration gas into the cavity within the adsorber through the air inlet; after dispersion treatment by the airflow distribution plate on the regeneration gas, performing regeneration treatment on the saturated adsorption bed layer to obtain a desorbed gas, condensate, and a regenerated adsorption bed layer; and extracting the desorbed gas through the air outlet; and
(4) performing cooling treatment on the regenerated adsorption bed layer.

14. The adsorption method according to claim 13, wherein when the gas to be adsorbed is air and the desorbed gas is carbon dioxide, the adsorption bed layer comprises an adsorbent, and a ratio of an adsorption amount of carbon dioxide to a mass of the adsorbent is 0.9 to 2 mmol/g.

15. The adsorption method according to claim 14, wherein a calculation formula for calculating an adsorption amount of the adsorbent for carbon dioxide is:
average CO₂ adsorption amount=(inlet concentration−outlet concentration)×airflow rate×adsorption time/adsorbent mass.

16. The adsorption method according to claim 14, wherein a particle size distribution of the adsorbent is 0.3 to 1.5 mm, and the adsorbent comprises a solid amine adsorbent material.

17. The adsorption method according to claim 13, wherein in step (1), an inflow rate of the gas to be adsorbed is 200 to 300 Nm³/h; and a temperature of the adsorption treatment is 20 to 40° C., and a time of the adsorption treatment is 100 to 120 min.

18. The adsorption method according to claim 13, wherein in step (3), the regeneration gas is water vapor, a temperature of the regeneration treatment is 80 to 120° C., and a time of the regeneration treatment is 10 to 30 min; and the regeneration treatment comprises direct steam purging regeneration treatment.

19. An adsorption system, comprising the adsorber according to claim 1.

20. The adsorption system according to claim 19, further comprising a gas-to-be-adsorbed purifying and cooling device, an adsorption device, a regeneration gas generating device, and a separation device;
wherein the adsorption device comprises at least one adsorber;
an outlet of the gas-to-be-adsorbed purifying and cooling device is communicated with the air inlet of the adsorber, and the air outlet of the adsorber is configured to output adsorbed gas;
an outlet of the regeneration gas generating device is communicated with the air inlet of the adsorber, and the air outlet of the adsorber is further communicated with an inlet of the separation device; and a gas phase outlet of the separation device is configured to output a product gas, and a liquid phase outlet of the separation device is communicated with a return port of the regeneration gas generating device.
